(19) United States
(12) Patent Application Publication
(10) Pub. No.: US 2020/0399797 A1
(43) Pub. Date: Dec. 24, 2020

(54) SCRIM MATERIAL HAVING LOW TENACITY WEFT FIBERS

(71) Applicant: HIGHLAND INDUSTRIES, INC., Kernersville, NC (US)

(72) Inventors: Josephine Jarrett, Hartsville, SC (US); Justin Barnett, Greensboro, NC (US)

(73) Assignee: HIGHLAND INDUSTRIES, INC., Kernersville, NC (US)

(21) Appl. No.: 16/449,639

(22) Filed: Jun. 24, 2019

(51) Int. Cl. D03D 9/00; B32B 5/26; B32B 5/06; B32B 5/02

(52) U.S. Cl. CPC D03D 9/00; B32B 5/26; B32B 5/024; B32B 5/022; B32B 5/06

(57) ABSTRACT

A scrim that is more readily recycled by grinding is disclosed and has a plurality of high tenacity fibers or yarns having a tenacity of at least about five (5) grams per denier and oriented in the warp direction and a plurality of low tenacity fibers or yarns having a tenacity of less than about four (4) grams per denier and oriented in the weft direction. In preferred embodiments, the low tenacity fibers or yarns comprise textured fibers or spun and undrawn fibers.

### FIELD OF THE INVENTION

The present invention relates generally to scrim and relates more specifically to an easily recycled scrim having low tenacity weft fibers.

### DESCRIPTION OF THE PRIOR ART AND OBJECTIVES OF THE INVENTION

Scrim is a type of material having at least two layers of spaced apart parallel strands of fibers in which one layer of fibers is oriented perpendicular to the other, forming a structure resembling a net or mesh. A scrim can be a woven product, in which case the strands of fibers are interlaced in a pattern, for example by alternately placing fibers in the warp direction over and under the fibers in the weft direction. Or a scrim can be a nonwoven product, in which case the strands are bonded together at the points where the strands of fibers intersect, typically (but not exclusively) through thermal or chemical bonding. Scrim has been widely used as support and/or reinforcement of plastic films, paper and nonwoven webs.

While many different natural and synthetic fibers have been proposed and used over the years to make scrim, it is conventional practice to use high tenacity fibers to improve the durability of the scrim and the material resulting from the lamination of the scrim to another web, such as a nonwoven fibrous web or matt. For applications requiring a material with high strength-to-weight ratios, high tenacity polyester fibers are commonly employed. By its nature, the process of manufacturing nonwoven fibrous materials produces a web that is not homogeneous across its width and length. The outermost edges of the web, whether in the longitudinal or lateral directions, are of poor and inconsistent quality and thus need to be removed. Moreover, it is common for nonwoven fibrous webs to be made in larger widths and lengths and then cut to the size needed for the intended application. Accordingly, it is necessary to cut the web to at least remove the outermost edges (commonly referred to as “trim”) to improve the homogeneity of the web before undertaking any further processing. For reasons of efficiency, cost and conservation, it is desirable to recycle that trim back into the process instead of collecting it for disposal in a landfill. However, for applications in which a scrim containing high tenacity fibers or yarns, such as high tenacity polyester fibers, the presence of the high tenacity yarns do not allow for proper grinding of the trim and thus precludes the ability to recycle the material back into the process.

Accordingly, it is an objective of the present invention to provide a scrim that is more readily recycled.

It is another objective of the present invention to provide an easily recycled scrim that can be used as a support or reinforcement for plastic film, paper or nonwoven fibrous web.

It is still another objective of the present invention to provide an easily recycled scrim in which the strength of the scrim is defined substantially in the warp direction.

It is yet a further objective of the present invention to provide an easily recycled scrim having high tenacity fibers in the warp direction and low tenacity fibers in the weft direction.

Still another objective of the present invention is to provide an easily recycled scrim having high tenacity fibers in the warp direction and low tenacity fibers in the weft direction, wherein the low tenacity fibers are either textured or spun fibers or yarns.

Various other objectives and advantages of the present invention will become apparent to those skilled in the art as a more detailed description is set forth below.

### SUMMARY OF THE INVENTION

A scrim fabric has a plurality of fibers oriented in the warp direction and a plurality of fibers oriented in the weft direction. The warp fibers are high tenacity fibers, whereas the weft fibers are low tenacity fibers. The high tenacity fibers have a tenacity of at least about five (5) grams per denier and the low tenacity fibers have a tenacity of less than about four (4) grams per denier. In preferred embodiments, the low tenacity fibers are either textured fibers or spun and undrawn fibers.

### DETAILED DESCRIPTION OF THE PREFERRED EMBODIMENT AND OPERATION OF THE INVENTION

The scrim of this invention has a plurality of fibers oriented in the warp direction and a plurality of fibers oriented in the weft direction. As is conventional, the warp and weft directions are oriented generally perpendicular to one another. The terms “warp” and “weft” are generally so used for fabric materials that are produced by weaving. However, the scrim of the present invention is not limited to woven scrim products, but instead may also be a nonwoven scrim. In a typical web manufacturing process, the web is produced in a continuous process wherein the warp direction is synonymous with the machine direction and corresponds typically to the length of the web. The weft direction corresponds to the width of the web and is synonymous with the cross direction. The terms “warp” and “weft” as used herein will follow their conventional meaning when referring to a woven material, and will refer to the machine direction and the cross direction, respectively, when referring to a nonwoven material.

As generally used in the art, the term “fiber” can refer to either a staple fiber or a filament fiber, depending on the length. A staple fiber is a fiber having a discrete length (usually no more than a few inches), whereas a filament fiber is continuous fiber of indefinite length. Although there are examples of natural filament fibers, such as silk, most filament fibers are man-made or synthetic materials. The term “yarn” refers to an assembly of fibers that have been intertwined together, typically by twisting. Sometimes the term “filament yarn” is used in the art and refers to a filament that is long enough and strong enough to act as a yarn. However, because a filament yarn is a single filament, it is not a true yarn.

As mentioned above, scrim is often used as a support or reinforcement layer for a fibrous nonwoven fabric. Nonwoven fabrics are broadly defined as sheet or web structures bonded together by mechanical, thermal or chemical processes and are made directly from separate fibers, molten plastic or, in some cases, plastic film. The fibers in a nonwoven fabric are not woven or knitted together and do not require converting the fibers to yarn.

In one process, the nonwoven fabric may be formed by a mechanical process known as needle punching, which is a form of mechanical bonding that converts a collection of loose staple fibers into a coherent nonwoven fabric using a needle loom. The needle loom has a plurality of very closely spaced barbed needles secured to a platen which moved in an up/down motion to pass through the loose fibers. As the needles move though the fibers, they punch fibers into the matt and withdraw, leaving the fibers entangled. By varying the number of strokes per minute, the advance rate of the fibers, the number of needles on the platen, and the depth of penetration of the needles, a wide range of fabric densities can be obtained. When the scrim is used as a support or reinforcement for the needle punched fabric, the scrim is brought into intimate contact with the loose fibers and both layers are subjected to the needle punch process together. See, for example, U.S. Pat. Nos. 3,819,465 and 5,928,973, the disclosures of which are incorporated herein by reference in their entireties.

Nonwoven fabrics made from a needle punch process are typically free of chemical adhesives and are not bonded together by a thermal process, and as such they are normally very attractive candidates for recycling of the trim removed from the web. The recycling process generally involved grinding of the trim removed from the web to produce a collection of staple fibers which can then be fed back into the manufacturing process. The presence of high tenacity fibers interferes with the ability to grind the trim, making it difficult if not impossible to recycle the material removed from the webs.

Applicants have solved the problem by replacing the high tenacity fibers at the selvedge with textured or spun fibers while maintaining the use of high tenacity fibers in the warp direction. The scrim thus satisfies the need for scrim that provides the needed strength to weight ratio for many applications, while also significantly improving the sustainability of the process by enhanced recycling of the trim that would otherwise need to be disposed of as solid waste. The tenacity of a fiber is the mass stress at break and is defined as the specific stress corresponding with the maximum force on the force/extension curve for the particular fiber. Conventionally, tenacity is expressed as grams/denier and indicates the amount of force applied to the fiber at break divided by the denier of the fiber. High tenacity fibers useful in the present invention comprise any well known and used fiber with a tenacity of at least five (5) grams/denier and fibers having a tenacity of greater than nine (9) grams/denier are considered super high tenacity. High tenacity polyester fibers are particularly preferred, but other fibrous materials meeting the tenacity threshold may also be employed to advantage. For example, U.S. Pat. No. 4,276,348 (the disclosure of which is incorporated herein by reference) teaches polyethylene fibers with a tenacity of at least twelve (12) grams/denier. The warp fibers used in the scrim of the present invention are any of the known high tenacity fibers, i.e., those having a tenacity of at least about five (5) grams/denier and more preferably at least about seven (7) grams per denier. A particularly preferred fiber is high tenacity polyester.

The weft fibers used in the scrim of the invention are low tenacity fibers. The low tenacity weft fibers have a tenacity of less than about four (4) grams per denier, more preferably less than about three (3) grams per denier. In a preferred embodiment, the weft fibers are textured or spun fibers or yarns. The term “texturing” refers to the physical deformation of fibers or yarns to form crimps, loops, coils, or crinkles. These physical characteristics weaken the fiber or yarn and make them suitable for grinding and recycling. Texturing of fibers or yarns is a well known process and, accordingly, need not be described herein in further detail.

A spun fiber is a fiber made by a process using a spinneret. The polymer is first converted to a fluid state, such as by melting or dissolving the polymer in a suitable solvent. The fluid polymer is then forced through the spinneret and forms a solid fiber as it cools, or as the solvent is evaporated. There are several known spinning processes used to make fibers, including wet spinning, dry spinning, melt spinning, etc. These processes are well known to those skilled in the art and need not be discussed herein in further detail. After spinning, the fiber is typically drawn, which crystallizes and orients the polymer. As taught by U.S. Pat. No. 2,604,689 (the entire disclosure of which is incorporated herein by reference), without the drawing step, fibers produced by spinning alone are typically weak and have low tenacity. In addition, the spinning process often uses polymers of lower molecular weight, which also tends to result in lower tenacity materials. After drawing, however, the tenacity of the fibers can increase into what is considered a high tenacity fiber. Accordingly, spun and undrawn fibers are the preferred spun fibers for use as the weft fibers in the scrim of the invention.

The illustrations and examples provided herein are for explanatory purposes and are not intended to limit the scope of the appended claims.

We claim:

1. A scrim defined by warp fibers comprising high tenacity fibers and weft fibers comprising low tenacity fibers, wherein the weft fibers further define a selvedge.

2. The scrim of claim 1, wherein the high tenacity fibers have a tenacity of at least about 5 grams per denier.

3. The scrim of claim 1, wherein the low tenacity fibers have a tenacity of less than about 4 grams per denier.

4. The scrim of claim 1, wherein the high tenacity fibers have a tenacity of at least about 7 grams per denier and the low tenacity fibers have a tenacity of less than about 3 grams per denier.

5. The scrim of claim 1, wherein the warp fibers comprise yarns.

6. The scrim of claim 1, wherein the weft fibers comprise yarns.

7. The scrim of claim 1, wherein the weft fibers comprise textured fibers.

8. The scrim of claim 1, wherein the weft fibers comprise textured yarns.

9. The scrim of claim 1, wherein the weft fibers comprise spun fibers.

10. The scrim of claim 1, wherein the weft fibers comprise spun and undrawn fibers.

11. The scrim of claim 1, wherein the weft fibers comprise yarns comprised of spun fibers.

12. The scrim of claim 1, wherein the weft fibers comprise yarns comprised of spun and undrawn fibers.

13. The scrim of claim 12, wherein the weft fibers are formed into yarns.

14. The scrim of claim 1, further comprising a nonwoven web laminated to said scrim.

15. The scrim of claim 1, further comprising a nonwoven web of staple fibers laminated to said scrim by a needle punching process.

16. The scrim of claim 1, further comprising a nonwoven web of staple fibers laminated to said scrim by a needle punching process, wherein the weft fibers comprise textured fibers.

17. The scrim of claim 1, further comprising a nonwoven web laminated to said scrim, wherein said weft fibers comprise yarns comprised of spun and undrawn fibers.

18. The scrim of claim 1, further comprising a nonwoven web of staple fibers laminated to said scrim in a needle punch process, wherein said weft fibers comprise yarns comprised of spun and undrawn fibers.

19. The scrim of claim 1, further comprising a nonwoven web of staple fibers laminated to said scrim in a needle punch process, wherein said weft fibers comprise yarns comprised of textured fibers.
